(19) United States
(12) Patent Application Publication
(10) Pub. No.: US 2014/0344206 A1
(43) Pub. Date: Nov. 20, 2014

(54) VERIFYING LEGITIMATE FOLLOWERS IN SOCIAL NETWORKS

(71) Applicant: International Business Machines Corporation, Armonk, NY (US)

(72) Inventors: Yu Deng, Yorktown Heights, NY (US); Jenny S. Li, Danbury, CT (US); Liangzhao Zeng, Yorktown Heights, NY (US)

(73) Assignee: International Business Machines Corporation, Armonk, NY (US)

(21) Appl. No.: 13/895,508

(22) Filed: May 16, 2013

(51) Int. Cl. G06N 5/04

(52) U.S. Cl. CPC G06N 5/04
USPC 706/47

(57) ABSTRACT

A method for verifying a legitimate follower in a social network account assigned to a user is provided. The method may include generating a set of user defined rules associated with verifying a follower request. The method may further include monitoring the social network account assigned to the user to identify the follower request and analyzing the identified follower request to determine the legitimate follower based on the set of user-defined rules.

### FIELD OF THE INVENTION

The present invention relates generally to the field of social networking using a computer on a communication network, and more particularly to the screening of followers in social networks.

### BACKGROUND

A social networking service is an online service, platform, or site that focuses on facilitating the building of social networks or social relations among people who, for example, share interests, activities, backgrounds, or real-life connections. A social network service consists of a representation of each user, i.e., a profile, the user's social links, and a variety of additional services. Most social network services are web-based and provide means for users to interact over the Internet, such as e-mail and instant messaging. Social networking sites allow users to share ideas, activities, events, and interests within their individual networks. Additionally, many social networking sites allow users to “follow” one another. For example, if Instagram integrated Facebook “Follow”, then when a person followed someone new on Instagram, they would get their photos in their Facebook news feed. A news feed on Facebook is the center column of a user's home page. It is a constantly updating list of stories from people and pages that the user follows on Facebook. News feed stories include status updates, photos, videos, links, application activity, etc.

The “follow” action allows followers to receive an endless stream of updates. As long as the person being followed keeps doing things in the application where the “follower” subscribed, the “follower” will continue seeing their content in the news feed. For example, when user A follows user B, user A subscribes to user B's postings or news so that user B's postings or news will show up in user A's news feed.

However, there may be security risks involved in allowing users to “follow” one another since not all “followers” may be legitimate followers. A legitimate follower may be a follower the user would allow to follow them. For example, the legitimate follower may be a real person who may be interested in the content the user provides, share common interests or hobbies with the user they want to follow. However, a follower may not be a real person and may have malicious intent when requesting to follow a user. For example, “followers” may be a machine program or Internet bots (i.e. “ghost followers” or “zombie followers”). Internet bots, also known as web robots, WWW robots or simply bots, are software applications that run automated tasks over the Internet. As such, “ghost followers” may send harmful messages to the user's posting or they may use other malicious ways to cause trouble to both the user and the user's other “followers”. Furthermore, “ghost followers” may gain access to a list of other “followers” of the same user and as such, may potentially spam the other “followers”. Therefore, it may be advantageous, among other things, to provide a mechanism to distinguish legitimate followers from “ghost followers” or “spammers” in social networks.

### SUMMARY

According to at least one embodiment of the present invention, a method for verifying a legitimate follower in a social network account assigned to a user is provided. The method may include generating a set of user defined rules associated with verifying a follower request. The method may further include monitoring the social network account assigned to the user to identify the follower request and analyzing the identified follower request to determine the legitimate follower based on the set of user-defined rules.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 illustrates a networked computer environment with an exemplary program to distinguish legitimate followers on a social network according to one embodiment;

FIG. 3 is an operational flowchart illustrating the steps carried out by a program to distinguish legitimate followers on a social network according to one embodiment; and

FIG. 4 is a block diagram of internal and external components of computers and servers depicted in FIG. 1.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention relates generally to the “following” of one another on a social network and particularly to the screening of legitimate followers in social networks. The following described exemplary embodiments provide a system, method and program product to provide a mechanism to distinguish legitimate followers from “ghost followers” or “spammers” in social networks.

Many social networks allow members to “follow” one another across all their social network accounts, such as Twitter, YouTube, Facebook, Instagram and other major platforms. Social network account users may choose to “follow” someone based on a person's profile, shared interests or hobbies. For example, user A may wish to “follow” user B on Facebook because user A is interested in cooking and user B is a chef. As such, user A will be able to see user B's public updates in news feeds. As previously described, a news feed on Facebook is the center column of a user's home page. It is a constantly updating list of stories from people and pages that the user follows on Facebook. News feed stories include status updates, photos, videos, links, application activity, etc.

However, as described above, there may be security risks involved in allowing users to “follow” one another since not all “followers” may be legitimate users (i.e., a follower the user would allow to follow them). Having such a convenience feature established may result in illegitimate users, such as “ghost followers”, “zombie followers”, or “spammers” posing as a legitimate “follower”. A “ghost follower” or “zombie follower” may also be known as a bot. A bot is a computer that a remote attacker has accessed and set up to forward transmissions (including spam and viruses) to other computers on the Internet. The purpose is usually either financial gain or malice. Attackers typically exploit multiple computers to create a botnet, also known as a zombie army.

For example, if a “ghost follower” poses as a legitimate “follower”, the “ghost follower” could potentially gain access to a list of contact names from the attacked users (i.e., the people they follow). As such, the “ghost follower” may write scripts to spam this accessed list of contact names and therefore, the accessed names may receive unwanted spam messages. This may discourage users from “following” the attacked user if potential followers think they will be spammed on their own account by following the user. Furthermore, it may reduce the number of followers the attacked user has and potentially damage the attacked user's reputation if other followers see that the attacked user has received a large number of spam messages.

Currently, a user can block a follower from following them once the user determines that the follower is not a legitimate follower. This is a reactive, manual process taken by the user once the user investigates the follower and determines that the follower should be blocked. However, there are not any proactive measures available to investigate a follower when the follower requests to follow a user. As such, it may be advantageous to provide a preventative measure to distinguish legitimate followers from “ghost followers” or spammers prior to the user allowing the follower to follow them.

In one embodiment, legitimate followers are distinguished from “ghost followers” or spammers. The method uses preventative means to verify the follower's credentials or profile before allowing them to follow the user and establishes rules created by the user (i.e. a set of user-defined rues) which are used as criteria requirement when analyzing the follower. The method ensures the follower is a legitimate real user and not a computer program or “ghost follower” prior to allowing the follower to follow the user by performing an analysis of the follower's social network account and comparing the account to a set of pre-defined rules. The set of pre-defined rules consist of existing rules in a follower rule repository database combined with the set of user-defined rules. If the follower's profile fails the criteria requirement of the set of pre-defined rules (i.e., the follower rule repository and the user-defined rules), then the follower will not be allowed to follow the user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Currently, many social networks allow members to “follow” one another across all their social network accounts. A user can block a follower from following them once the user has allowed the follower to follow them and the user determines based upon the follower's activity that the follower is not a legitimate follower. For example, if user A allows user B to follow them and then user B posts marketing messages about products they are selling, user A can then block user B from following them. This is a manual process that has to be performed for each illegitimate user on each social network account. The user would have to perform an investigation for each follower request before determining whether the user should be blocked.

The following described exemplary embodiments provide a system, method and computer program product to use a combination of an existing follower rule repository database along with a set of user-defined rules (i.e., the set of pre-defined rules) and existing technology to proactively prevent “ghost followers” or spammers from following a user. The present embodiment is different from the current state of the art since it provides an automatic and proactive means to validate if a follower is a real and legitimate follower. Additionally, it is a preventative means to prevent “ghost followers” or spammers from following a user as opposed the existing technologies that are reactive in nature.

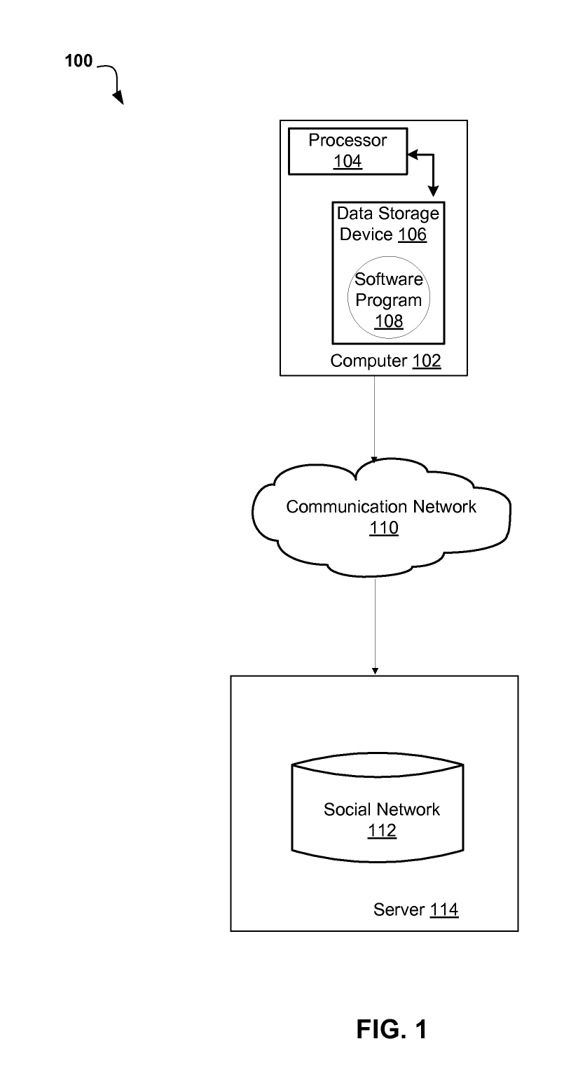

Referring to FIG. 1, an exemplary networked computer environment 100 in accordance with one embodiment is depicted. The networked computer environment 100 may include a computer 102 with a processor 104 and a data storage device 106 that is enabled to run a software program 108. The networked computer environment 100 may also include a social network 112, a server 114 and a communication network 110. The networked computer environment 100 may include a plurality of computers 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

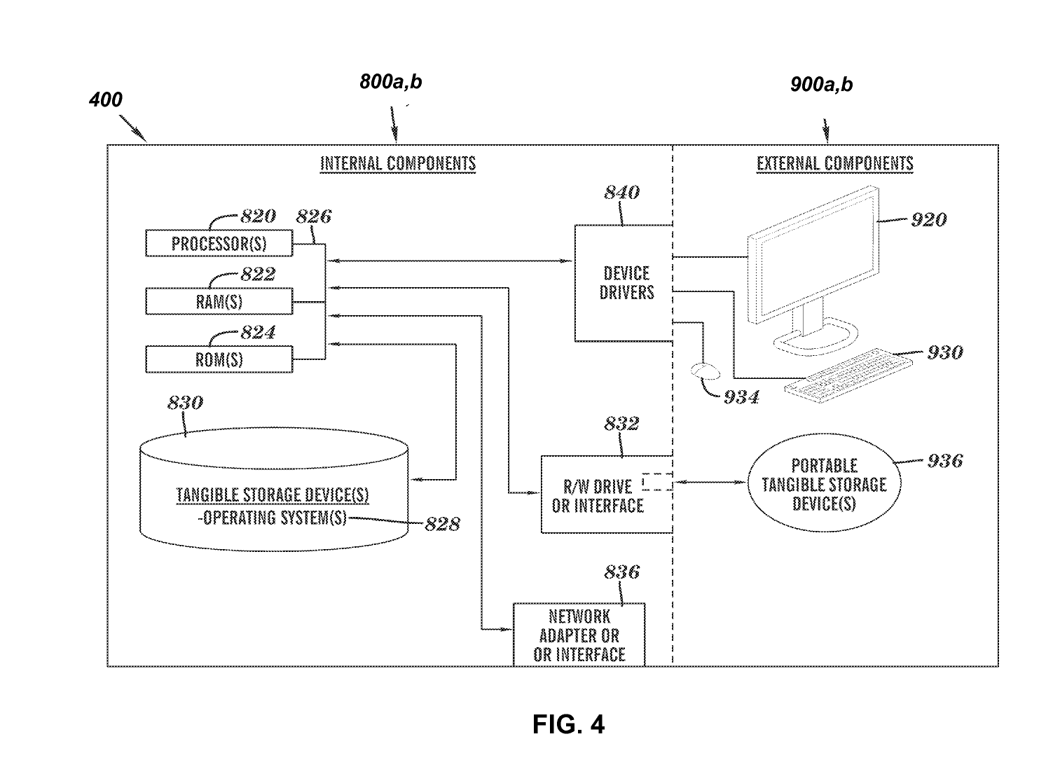

The client computer 102 may communicate with social network 112 running on server computer 114 via the communications network 110. The communications network 110 may include connections, such as wire, wireless communication links, or fiber optic cables. As will be discussed with reference to FIG. 4, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of accessing a social network.

As previously described, the client computer 102 may access social network 112, running on server computer 114 via the communications network 110. For example, a user using an application program 108 (e.g., Firefox®) running on a client computer 102 may connect via a communication network 110 to one of their social network accounts 112 which may be running on server computer 114.

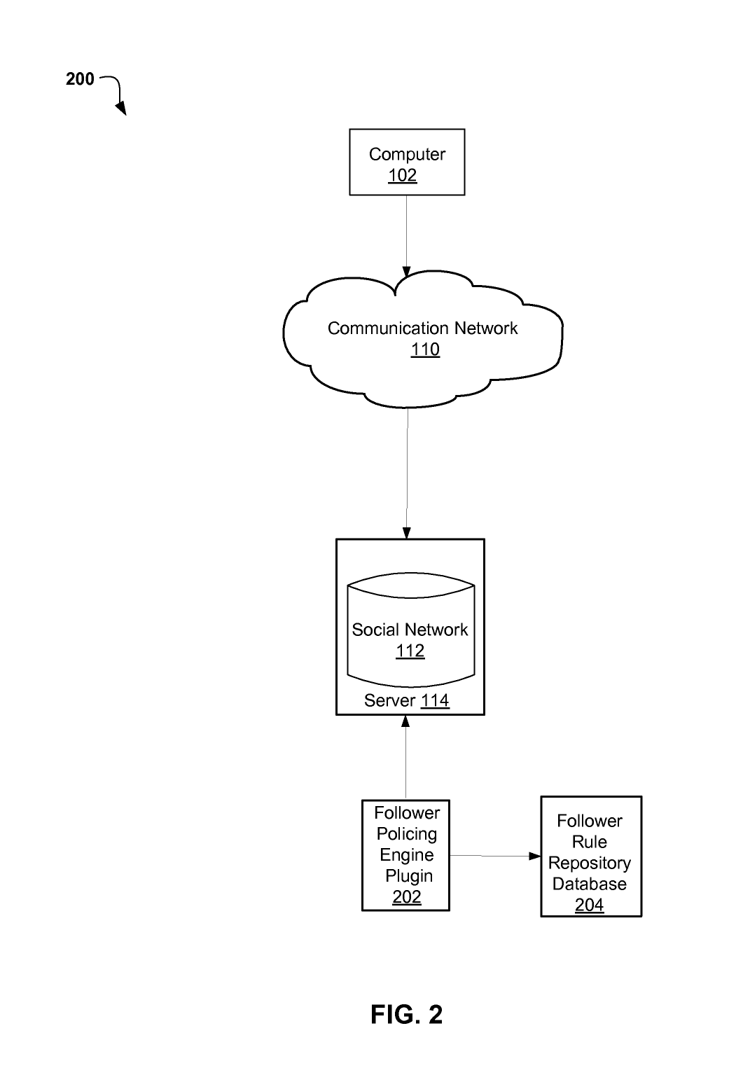

Referring now to FIG. 2, a networked computer environment with an exemplary follower policing engine plugin 202 in accordance with one embodiment is depicted. Client computer 102 may communicate via a communication network 110 with a social network 112 which may be running on a server computer 114. Proactively preventing “ghost followers” or spammers from following a user with a social network account in accordance with at least one embodiment may be implemented as follower policing engine plugin 202 to social network 112 which may be running on server computer 114 and interacting with follower rule repository database 204.

A plugin is a computer program that interacts with a main application (a web browser or an email program, for example) to provide a certain, usually very specific, function. The main application provides services which the plugins can use, including a way for plugins to register themselves with the main application and a protocol by which data is exchanged with plugins. Plugins are dependent on these services provided by the main application and do not usually work by themselves. Conversely, the main application is independent of the plugins, making it possible for plugins to be added and updated dynamically without changes to the main application. For example, follower policing engine plugin 202 may be a computer program that distinguishes legitimate followers from “ghost followers” or spammers in a social network 112, such as Twitter or Facebook (i.e. the main application).

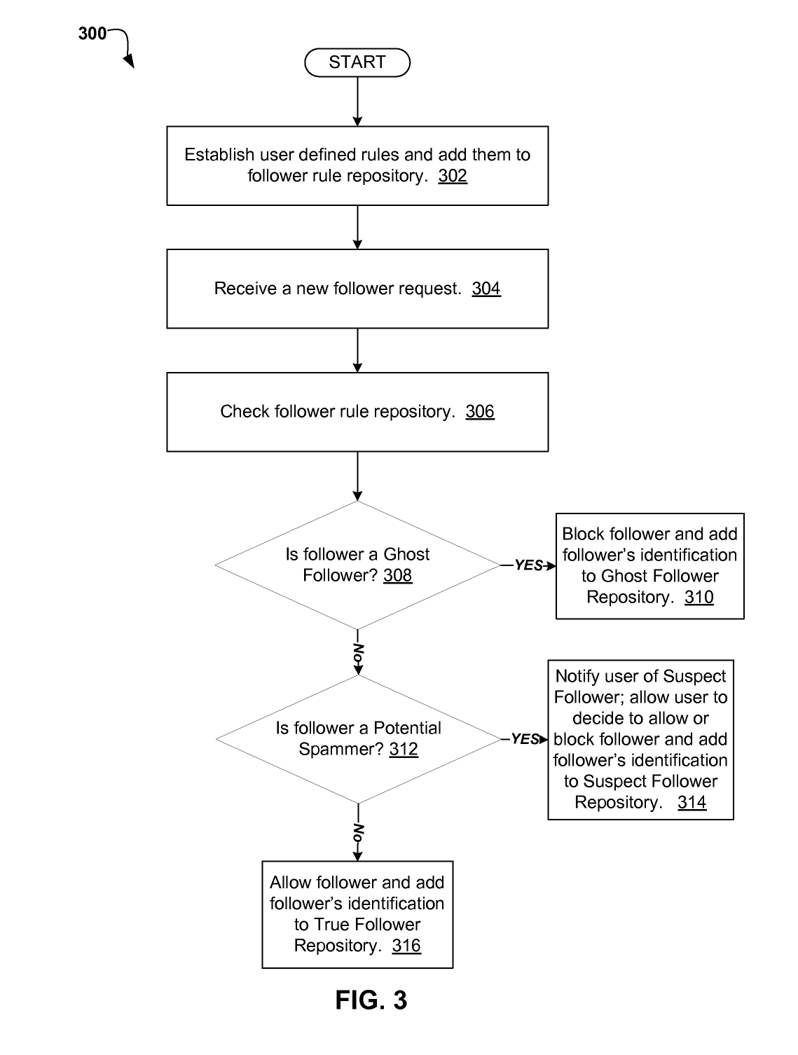

FIG. 3 is an operational flowchart illustrating the steps carried out by follower policing engine plugin 202 (FIG. 2) in accordance with an embodiment of the present invention. For example, the embodiment may be implemented as follower policing engine plugin 202 that interacts with a social network 112 (i.e. the main application) which may be running on server computer 114 and provides a preventative means to validate if a follower in a social network application is a real and legitimate follower as opposed to a “ghost follower” or spammer. The plugin may, for example, be displayed to the user using a graphical user interface (GUI) in order to obtain the necessary information needed to provide a set of user-defined rules which may be used in conjunction with an existing repository of rules (i.e., follower rule repository database 204) to determine if the follower is a real and legitimate follower. The set of user-defined rules may include, but is not limited to common hobbies or interests between the user and the follower. The existing follower rule repository database may include, but is not limited to determining the number of followers the follower has, how many people the follower follows and whether the follower's account is public or private. The follower policing engine plugin 202 may perform an analysis of the follower's existing social network account based on a set of pre-defined rules (i.e., the conjunction of the user defined rules and the follower rule repository 204). The validation of the follower as performed by follower policing engine plugin 202 interacting with social network 112 (which may be running on server computer 114) and interacting with follower rule repository database 204 is explained in more detail below with respect to FIG. 3.

Referring to FIG. 3, at 302 the user establishes a set of user-defined rules and the set of user-defined rules is added to an existing follower rule repository database 204 (FIG. 204). As previously described, the existing repository is dynamic and may consist of a series of rules to be checked against the follower's profile and usage history. The repository may include rules such as the following:
1. Does the follower have any followers?
2. How many people does the follower follow?
3. How many people follow the follower?
4. What is the ratio between the number of people that the follower follows VS the number of followers the follower has?
5. Does the follower have profile pictures?
6. What kind of information is in the follower's profile?
7. What kind of material or content has he posted so far?
8. Has the follower posted any offensive material?
9. Is the follower's profile public or private?

At 302, the user may be prompted with a graphical user interface to guide the user with establishing the set of user-defined rules which may be used to analyze the follower's profile and usage history. The set of user-defined rules are added to an existing follower rule repository database 204 (FIG. 2) to form a set of pre-defined rules. The user defined rules are based upon the user's social network preferences for followers. As previously described, the user defined rules may include, but are not limited to common hobbies or interests between the user and the follower. For example, if the user does not want any followers who enjoy hunting, then a rule would be established that would block users who describe themselves as hunters or frequently comment on hunting. The method provides means to verify the follower's credentials or profile before allowing them to follow the user and establishes a set of pre-defined rules which includes a set of user-defined rules that are added to an existing repository of rules (i.e., follower rule repository database 204 (FIG. 2) as criteria requirement when analyzing the follower.

Next, at 304 (FIG. 3), follower policing engine plugin 202 (FIG. 2) receives a new follower request. Then at 306, follower policing engine plugin 202 checks the follower rule repository database 204 and determines if the follower is a “ghost follower”, a potential “spammer follower” or a “true follower”. The method may ensure that the follower is a legitimate real follower, not a computer program, “ghost follower” or spammer, and shares common interests with the user prior to allowing the follower to follow the user. For example, if the follower's profile fails the set of criteria requirement of the user-defined rules and the rules of the follower rule repository (i.e., the set of pre-defined rules), then the follower may not be allowed to follow the user and the follower's identification may be added to a “ghost follower” repository. If the follower's profile is within a certain limit of passing the combined criteria requirement of the user-defined rules and the rules of the existing repository, then the user may be notified that the follower is a potential spammer. Additionally, the user may decide whether the follower may be allowed to follow the user and follower's identification may be added to a “suspect follower” repository. If the follower's profile passes the combined criteria requirement of the user-defined rules and the rules of the existing repository, then the follower may be allowed to follow the user and the follower's identification may be added to a “true follower” repository. In one implementation, the user may receive a notification with the identifications of the blocked and allowed followers.

In addition to checking the user-defined rules and the follower rule repository to determine whether a follower is a “ghost follower”, potential spammer or “true follower”, existing technology may be used to examine the follower's existing profile and usage of the social networking account. The existing technology may also be used to analyze posted pictures, comments and context. For example, Optical Character Recognition (OCR) may be used to examine profile pictures and text posted by the follower. OCR can convert images with text into text documents using automated computer algorithms. Images can be processed individually (.jpg, .png, and .gif files) or in multi-page PDF documents. OCR is the mechanical or electronic conversion of scanned images of handwritten, typewritten or printed text into machine-encoded text. It is used as a form of data entry from an original paper data source. The data source may be photographs, documents, or any type of printed records. It is a common method of digitizing printed texts so that they can be electronically searched, stored more compactly, displayed online, and used in machine processes such as machine translation, text-to-speech and text mining. For example, one embodiment of the present invention may engage the existing technology OCR to examine a profile photograph of the follower. OCR may be able to examine the pixels and content of the posted photograph and; therefore, determine if the photograph is of a person or a marketing product. If a marketing product is determined, then the method may notify the user that the follower appears to be soliciting the sales of products (i.e., a potential spammer) and may recommend that the user block the follower.

Additionally, the profile may be examined in terms of how long the follower has had an account and the date associated with their posted content. For example, a brand new account may appear to be more suspicious than an account that has been in use for a long time.

The method may also examine hashtags to obtain the context of a user's profile. A hashtag is a word or a phrase prefixed with the symbol # a form of metadata tag. Short messages on microblogging social networking services such as Twitter or Instagram may be tagged by including one or more # with multiple words concatenated, e.g.: #Summer Sweepstakes. Hashtags provide a means of grouping such messages and can aid in searching since a user may search for the hashtag and receive the set of messages that contain that hashtag. With respect to the example above, a user could search on #Summer Sweepstakes and receive all the messages that contain the hashtag #Summer Sweepstakes. The present embodiment may examine hashtags to determine whether a follower should be blocked. For example, a user may define a rule that does not allow hunters or any followers whose profiles contain context pertaining to hunting to follow them. Therefore, the existing method may search the hashtags of a follower to determine if the follower is a hunter or if any references to hunting have been made on the follower's account. Additionally, the present embodiment may search hashtags to determine if inappropriate messages have been posted.

Another implementation may be for the method to incorporate the use of a point system. Each rule may be worth a certain number of points. The method may analyze the follower's social network account and compare it to the rule repository. The method may assign points based the answers to the follower rule repository questions. For example, if the follower posts pictures, then 10 points may be assigned. If the total amount of points is equal to or exceeds a predefined threshold, then the follower may be deemed a “true follower” and may be allowed to follow the user. If the total amount of points is close to the threshold (i.e., within 20 points), then the follower may be deemed a potential spammer (i.e., “suspect follower”) and the user may ultimately decide whether to allow the follower follow them. If the total number of points is below the threshold (i.e., more than 20 points below), then the follower may be determined to be a “ghost follower” and may be blocked from following the user. For example, the threshold may be set to 50 points. If it is determined that the total number of points assigned to the follower is equal to or greater than 50, then the follower may be determined to be a “true follower” and may be allowed to follow the user. If it is determined that the total number of points assigned to the follower is between 30 and 49, then the follower may be determined to be a potential spammer (i.e., “suspect follower”) and the user may be prompted to decide as to whether the follower may be allowed to follow the user. If it is determined that the total number of points assigned to the follower is less than 30 then the follower may be determined to be a “ghost follower” and may be blocked from following the user.

As such, if at 308, follower policing engine plugin 202 (FIG. 2) determines that the follower is a “ghost follower” based upon the previously described criteria of checking the set of pre-defined rules (i.e., the follower rule repository 204 (FIG. 2) along with the user-defined rules); analyzing the follower's social network account profile; using existing technology such as OCR to analyze the follower's photos; and analyzing the follower's hashtags, then at 310, the follower may be blocked and the follower's identification may be added to a “ghost follower” repository which may contain the identifications of blocked followers. For example, the follower policing engine plugin 202 may determine that the user is a “ghost follower” if the score given to the follower is less than 30 after the above analysis was completed and as such, the follower would be blocked from following the user and the follower's identification may be added to the “ghost follower” repository.

If, at 308, follower policing engine plugin 202 (FIG. 2) determines that the follower is not a “ghost follower”, then at 312, follower policing engine plugin 202 (FIG. 2) may determine whether the follower is a potential spammer based upon the previously described criteria of checking the set of pre-defined rules (i.e., the follower rule repository 204 (FIG. 2) along with the set of user-defined rules); analyzing the follower's social network account profile; using existing technology such as OCR to analyze the follower's photos, and analyzing the follower's hashtags.

As such, if at 312, follower policing engine plugin 202 (FIG. 2) determines that the follower is a potential spammer, then at 314, the user may be notified that the follower is a “suspect follower”. Additionally, the user may be prompted to decide whether to allow or block the follower and the follower's identification may be added to a “suspect follower” repository which may contain the identifications of potential spammers. For example, the follower policing engine plugin 202 may determine that the user is a potential spammer if the score given to the follower is between 30 and 49 after the previously described analysis was completed and as such the user may be prompted to allow or block the follower in addition to the follower's identification being added to the “suspect follower” repository.

If at 316, follower policing engine plugin 202 (FIG. 2) determines that the follower is not a “ghost follower” or a potential spammer, then the follower may be allowed to follow the user and the follower's identification may be added to a “true follower” repository. For example, the follower policing engine plugin 202 may determine that the user is a true follower if the score given to the follower is equal to or greater than 50 after the previously described analysis was completed and the follower's identification may be added to the “true follower” repository. Additionally, another implementation may be for the method to use the set of follower rules to re-evaluate the existing list of followers periodically to ensure they are legitimate followers.

FIG. 4 is a block diagram of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102, and network server computer 114 include respective sets of internal components 800a, b and external components 900a, b illustrated in FIG. 4. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and program 108 in client computer 102 are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. The follower policing engine plugin 202 can be stored on one or more of the respective portable computer-readable tangible storage devices 936, read via the respective R/W drive or interface 832 and loaded into the respective hard drive 830.

Each set of internal components 800a, b also includes network adapters or interfaces 836 such as a TCP/IP adapter cards, wireless wi-fi interface cards, or 3G or 4G wireless interface cards or other wired or wireless communication links. The program 108 in client computer 102 and social network program 112 in network server 114 can be downloaded to client computer 102 from an external computer via a network (for example, the Internet, a local area network or other, wide area network) and respective network adapters or interfaces 836. From the network adapters or interfaces 836, the program 108 in client computer 102 and the social network program 112 in network server computer 114 are loaded into the respective hard drive 830. The network may comprise copper wires, optical fibers, wireless transmission, routers, firewalls, switches, gateway computers and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive or to imit the invention to the precise form disclosed. Many modifications and variations are possible. Such modifications and variations that may be apparent to a person skilled in the art of the invention are intended to be included within the scope of the invention as defined by the accompanying claims.

What is claimed is:

1. A processor-implemented method for verifying a legitimate follower in a social network account assigned to a user, comprising:
generating, by a processor, a set of user-defined rules associated with verifying a follower request;
monitoring, by the processor, the social network account assigned to the user to identify the follower request; and
analyzing the identified follower request to determine the legitimate follower based on the set of user-defined rules.

2. The method of claim 1, wherein the set of user-defined rules includes at least one social network preference that the user requires for analyzing the follower request.

3. The method of claim 1, further comprising:
adding, by the processor, the set of user-defined rules to a rule repository.

4. The method of claim 1, wherein analyzing the follower request comprises comparing a social network account assigned to the follower to a set of pre-defined rules.

5. The method of claim 4, wherein the set of pre-defined rules comprises a set of existing rules contained in a rule repository combined with the generated set of user-defined rules.

6. The method of claim 1, further comprising:
preventing the follower from following the user based on the comparing of the social network account assigned to the follower to the set of pre-defined rules.

7. The method of claim 6, wherein preventing the follower from following the user comprises determining whether the follower is at least one of a ghost follower, a suspect follower, and a true follower.

8. A computer system for verifying a legitimate follower in a social network account assigned to a user, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to generate a set of user-defined rules associated with verifying a follower request;
program instructions to monitor the social network account assigned to the user to identify the follower request; and
program instructions to analyze the identified follower request to determine the legitimate follower based on the set of user-defined rules.

9. The computer system of claim 8, wherein the set of user-defined rules includes at least one social network preference that the user requires for analyzing the follower request.

10. The computer system of claim 8, further comprising:
program instructions to add the set of user-defined rules to a rule repository.

11. The computer system of claim 8, wherein analyzing the follower request comprises comparing a social network account assigned to the follower to a set of pre-defined rules.

12. The computer system of claim 11, wherein the set of pre-defined rules comprises a set of existing rules contained in a rule repository combined with the generated set of user-defined rules.

13. The computer system of claim 8, further comprising:
program instructions to prevent the follower from following the user based on the comparing of the social network account assigned to the follower to the set of pre-defined rules.

14. The computer system of claim 13, wherein preventing the follower from following the user comprises determining whether the follower is at least one of a ghost follower, a suspect follower, and a true follower.

15. A computer program product for verifying a legitimate follower in a social network account assigned to a user, the computer program product comprising:
one or more computer-readable storage devices and program instructions stored on at least one of the one or more tangible storage devices, the program instructions comprising:
program instructions to generate a set of user-defined rules associated with verifying a follower request;
program instructions to monitor the social network account assigned to the user to identify the follower request; and
program instructions to analyze the identified follower request to determine the legitimate follower based on the set of user-defined rules.

16. The computer program product of claim 15, wherein the set of user-defined rules includes at least one social network preference that the user requires for analyzing the follower request.

17. The computer program product of claim 15, further comprising:
program instructions to add the set of user-defined rules to a rule repository.

18. The computer program product of claim 15, wherein analyzing the follower request comprises comparing a social network account assigned to the follower to a set of pre-defined rules.

19. The computer program product of claim 18, wherein the set of pre-defined rules comprises a set of existing rules contained in a rule repository combined with the generated set of user-defined rules.

20. The computer program product of claim 15, further comprising:
program instructions to prevent the follower from following the user based on the comparing of the social network account assigned to the follower to the set of pre-defined rules.
